(19) United States
(12) Patent Application Publication
(10) Pub. No.: US 2018/0222204 A1
(43) Pub. Date: Aug. 9, 2018

(54) LIQUID EJECTING APPARATUS

(71) Applicant: SEIKO EPSON CORPORATION, Tokyo (JP)

(72) Inventor: Hiromichi TAKANASHI, Shiojiri-shi (JP)

(21) Appl. No.: 15/874,397

(22) Filed: Jan. 18, 2018

(30) Foreign Application Priority Data
Feb. 9, 2017 (JP) 2017-022160

(51) Int. Cl. B41J 2/165

(52) U.S. Cl. CPC B41J 2/16535; B41J 2/16505

(57) ABSTRACT

A liquid ejecting apparatus includes a liquid ejecting head including a front end surface, an upstream surface that intersects with the front end surface, and a nozzle that opens at the front end surface, the liquid ejecting head being configured to eject liquid from the nozzle, and a wiping member configured to wipe the front end surface in a wiping direction. The upstream surface is located upstream of the front end surface in the wiping direction. A liquid repellent surface that repels the liquid is provided in a portion of the front end surface where the nozzle opens. A lyophilic surface having a higher affinity for the liquid than the liquid repellent surface is provided on the upstream surface and the front end surface. A portion of the lyophilic surface on the upstream surface is connected to a portion of the lyophilic surface on the front end surface.

### BACKGROUND

### 1. Technical Field

The present invention relates to a liquid ejecting apparatus such as a printer.

### 2. Related Art

As an example of a liquid ejecting apparatus, there is an ink jet recording apparatus that is provided with, in an ejection surface thereof, a concave portion that forms a hydrophilic portion around a water repellent surface that serves as a water repellent surface around nozzle rows so as to improve the ease of cleaning of the ejection surface (for example, JP-A-2007-253537).

Because ink that has adhered to the ejection surface accumulates at the hydrophilic portion, the paper in contact with the hydrophilic portion may become soiled with ink.

### SUMMARY

An advantage of some aspects of the invention is that a liquid ejecting apparatus in which a liquid does not tend to adhere to a medium is provided.

A liquid ejecting apparatus according to an aspect of the invention includes a liquid ejecting head including a front end surface, an upstream surface that intersects with the front end surface, and a nozzle that opens at the front end surface, the liquid ejecting head being configured to eject liquid from the nozzle, and a wiping member configured to wipe the front end surface by moving relative to the liquid ejecting head in a wiping direction. The upstream surface is located upstream of the front end surface in the wiping direction. A liquid repellent surface that repels the liquid is provided in a portion of the front end surface where the nozzle opens. A lyophilic surface having a higher affinity for the liquid than the liquid repellent surface is provided on the upstream surface and the front end surface. An upstream lyophilic surface that is a portion of the lyophilic surface on the upstream surface is connected to a front end lyophilic surface that is a portion of the lyophilic surface on the front end surface.

### BRIEF DESCRIPTION OF THE DRAWINGS

The invention will be described with reference to the accompanying drawings, wherein like numbers reference like elements.

FIG. 1 is an overall schematic diagram of an embodiment of a liquid ejecting apparatus.

FIG. 2 is a top view of a liquid ejecting head and a wiping member provided in the liquid ejecting apparatus of FIG. 1.

FIG. 3 is a schematic view for explaining the configuration of the wiping member and the liquid ejecting head of FIG. 2.

FIG. 4 is a cross-sectional view illustrating a configuration of the liquid ejecting head of FIG. 2 and a cap.

FIG. 5 is a cross-sectional view illustrating the configuration of the wiping member and the liquid ejecting head of FIG. 2.

FIG. 6 is a schematic view illustrating a wiping member and a liquid ejecting head according to a first modification example.

FIG. 7 is a cross-sectional view for explaining the configuration of the liquid ejecting head of FIG. 6.

FIG. 8 is a schematic view illustrating a wiping member and a liquid ejecting head according to a second modification example.

FIG. 9 is an overall schematic diagram of a liquid ejecting apparatus according to a third modification example.

FIG. 10 is a schematic view illustrating a wiping member and a liquid ejecting head according to a fourth modification example.

FIG. 11 is a schematic view illustrating a wiping member and a liquid ejecting head according to a fifth modification example.

### DESCRIPTION OF EXEMPLARY EMBODIMENTS

Hereinafter, an embodiment of the invention will be described with reference to the accompanying drawings. The liquid ejecting apparatus is an ink jet printer that performs recording (printing) by ejecting ink, which is an example of a liquid, onto a medium such as paper.

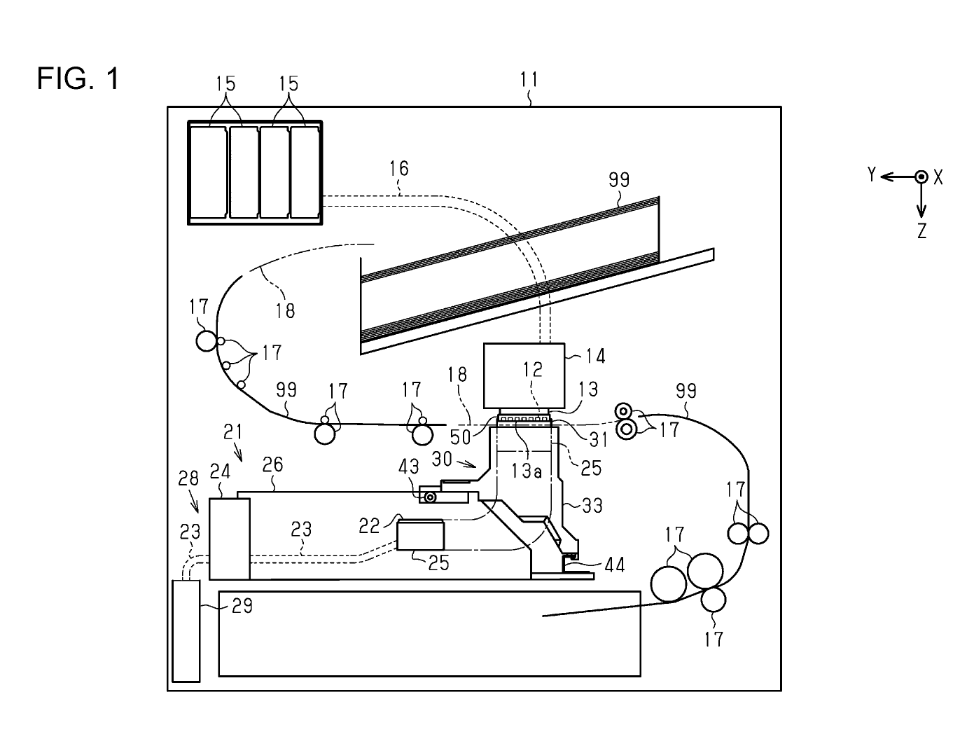

As illustrated in FIG. 1, a liquid ejecting apparatus 11 includes a liquid ejecting head 13, a holding unit 14 that holds the liquid ejecting head 13, a supply channel 16 disposed so as to supply liquid of liquid supply sources 15 toward the liquid ejecting head 13, and a plurality of transport rollers 17 disposed along a transport path 18 of a medium 99. The liquid supply sources 15 are, for example, cartridge-type liquid containers detachably mounted on the liquid ejecting apparatus 11. The liquid supply sources 15 may be a liquid tank that the liquid ejecting apparatus 11 is equipped with. The liquid tank may be formed so as to be exchangeable and so as to be capable of injecting a liquid.

The position at which the liquid ejecting head 13 ejects liquid onto the medium 99 is set as a recording position and the direction in which the liquid ejecting head 13 ejects liquid toward the recording position is set as an ejection direction Z. The transport path 18 of the medium 99 intersects the ejection direction Z of the liquid at the recording position. The direction in which the medium 99 is transported at the recording position is set as the transport direction Y.

The liquid ejecting head 13 is formed so as to have a front end surface 13a and nozzles 12 that open at the front end surface 13a and ejects liquid from the nozzles 12. The liquid ejecting head 13 of this embodiment is a line head in which a large number of the nozzles 12 are arranged in the width direction X intersecting the transport path 18 of the medium 99. The liquid ejecting head 13, which is a line head, is capable of printing over the entire width of the medium 99 moving in the transport direction Y. In the case where the ejection direction Z is the direction of gravity, the front end surface 13a is the lower surface of the liquid ejecting head 13.

The liquid ejecting apparatus 11 includes a maintenance device 21 configured so as to maintain the liquid ejecting head 13 at the recording position. The maintenance device 21 includes a suction mechanism 28, which is configured to suck the liquid in the liquid ejecting head 13, and a wiping device 30. The maintenance operation performed by the maintenance device 21 includes capping, suction cleaning and wiping.

The suction mechanism 28 includes a cap 22, a suction tube 23 extending from the cap 22, a suction pump 24 provided in the middle of the suction tube 23, a cap holder 25 for holding the cap 22, and a movement mechanism 26 that moves the cap 22. A waste liquid container 29 capable of housing waste liquid is connected to the downstream end of the suction tube 23.

“Capping” means forming a closed space to which the nozzles 12 open between the cap 22 and the liquid ejecting head 13 by the movement mechanism 26 moving the cap 22 to a capping position where the cap 22 comes into contact with the liquid ejecting head 13. The position of the cap 22 at the time of capping is indicated by a two-dot chain line in FIG. 1 and the movement path of the cap 22 toward the capping position is illustrated by a one-dot chain line in FIG. 1. When the liquid ejecting head 13 is not ejecting liquid, capping is carried out to suppress drying of the nozzles 12.

Suction cleaning is a maintenance operation in which the suction pump 24 is driven at the time of capping to discharge liquid from the nozzles 12. In suction cleaning, contaminants such as air bubbles that cause ejection failure are discharged from the inside of the liquid ejecting head 13 together with the liquid. The liquid discharged from the nozzles 12 by the suction cleaning is housed in the waste liquid container 29 as waste liquid.

The wiping device 30 includes a wiping member 31, a mobile body 33 that holds the wiping member 31, and a guide shaft 43 that guides the movement of the wiping member 31 via the mobile body 33. The wiping member 31 is configured to wipe the front end surface 13a by moving relative to the liquid ejecting head 13 in a wiping direction. A guide plate 44 may be additionally added as a member for guiding the movement of the wiping member 31. The wiping member 31 can be formed of, for example, an elastic body made of an elastomer or the like, or an absorber capable of absorbing liquid.

The guide shaft 43 is, for example, a screw shaft extending in the width direction X. The guide plate 44 is, for example, a sheet metal extending in the width direction X. The guide plate 44 is not essential and alternatively it is possible to stabilize the movement of the wiping member 31 by supporting the mobile body 33 with a plurality of members.

When the guide shaft 43, which is a screw shaft, rotates in a first rotation direction, the mobile body 33 moves forward in the width direction X and when the guide shaft 43 rotates in a second rotation direction, which is a direction opposite to the first rotation direction, the mobile body 33 moves backward in the direction opposite to the width direction X. The wiping member 31 contacts the liquid ejecting head 13 during at least one of the forward movement and the backward movement thereby wiping off any contaminants such as liquid that has adhered to the liquid ejecting head 13.

If contaminants adhere to the nozzles 12, droplets might not be ejected properly. The maintenance operation of wiping the liquid ejecting head 13 to suppress the likelihood of such ejection failure is called wiping. The wiping member 31 of this embodiment wipes the liquid ejecting head 13 when moving forward in the width direction X. In this case, the width direction X becomes the wiping direction.

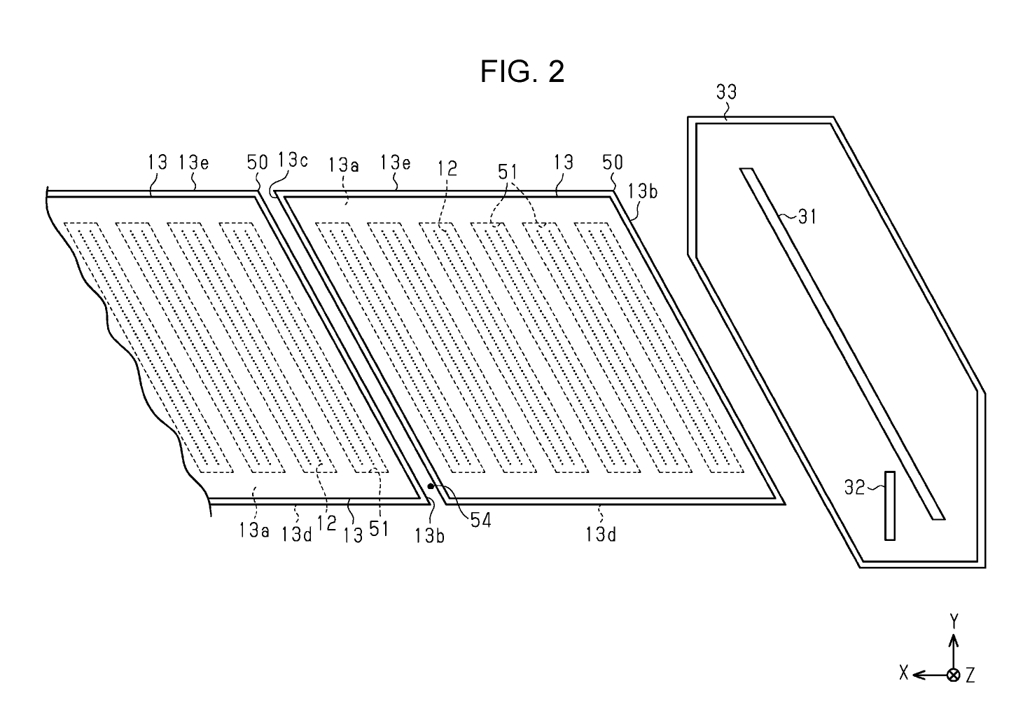

As illustrated in FIG. 2, the liquid ejecting head 13 has an upstream surface 13b, a downstream surface 13c on the opposite side to the upstream surface 13b, and side surfaces 13d and 13e intersecting the front end surface 13a. The side surfaces 13d and 13e intersect the front end surface 13a, the upstream surface 13b, and the downstream surface 13c and extend in the wiping direction. The upstream surface 13b is located upstream of the front end surface 13a in the wiping direction, and the downstream surface 13c is located downstream of the front end surface 13a in the wiping direction. The side surface 13d is located upstream of the front end surface 13a in the transport direction Y and the side surface 13e is located downstream of the front end surface 13a in the transport direction Y.

The plurality of nozzles 12 opening at the front end surface 13a constitute nozzle rows arranged in the width direction X. In the liquid ejecting head 13 of this embodiment, a plurality of nozzle rows are arranged at spaced intervals in the wiping direction. The nozzle rows may extend diagonally with respect to the width direction X and the transport direction Y. In this embodiment, two nozzle rows constitute one nozzle group, and a plurality of nozzle groups (six) are arranged at spaced intervals in the wiping direction.

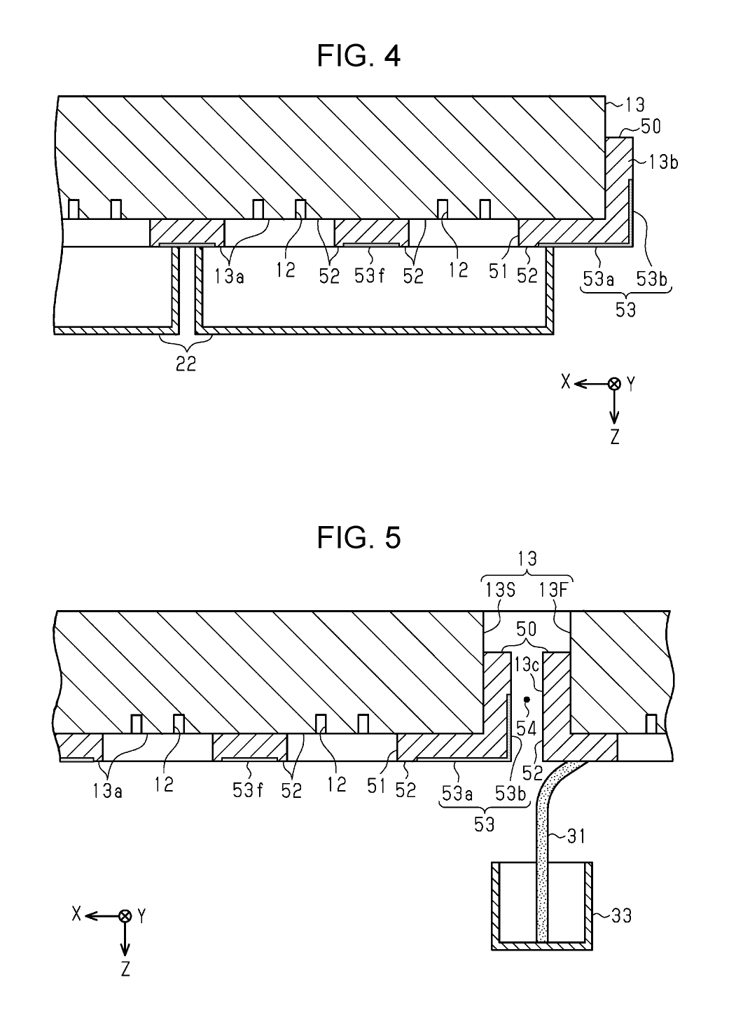

The liquid ejecting head 13 may have a fixing frame 50 having opening portions 51 for exposing nozzle rows for each nozzle group. In this case, a portion of the front end surface 13a, the upstream surface 13b, the downstream surface 13c, and the side surfaces 13d and 13e are provided in the fixing frame 50. The fixing frame 50 protrudes further in the ejection direction Z than the openings of the nozzles 12 (also refer to FIG. 4). Therefore, even when the medium 99 accidentally contacts the liquid ejecting head 13 when it passes through the recording position, contact of the medium 99 with the nozzles 12 is suppressed.

It is preferable that the wiping member 31 be arranged so as to extend in the direction in which the plurality of the nozzles 12 are arranged. Consequently, this makes it possible to efficiently wipe the openings of the plurality of nozzles 12 with the wiping member 31. When the nozzle rows are arranged diagonally with respect to the width direction and the transport direction Y, the wiping member 31 may also be arranged diagonally with respect to the width direction and the transport direction Y.

When the wiping member 31 is a first wiping member 31, the wiping device 30 may include a wiping member 32 that becomes a second wiping member 32 that wipes the side surface 13d by moving relative to the liquid ejecting head 13 in the wiping direction. In this case, the mobile body 33 may hold both the first wiping member 31 and the second wiping member 32. Because the side surface 13d is located upstream of the front end surface 13a in the transport direction Y, there is a possibility that the medium 99 being transported may come into contact with the side surface 13d. By removing the liquid that has adhered to the side surface 13d by using the second wiping member 32, the liquid does not tend to adhere to the medium 99.

The first wiping member 31 and the second wiping member 32 may be configured as separate members or one wiping member may be configured to wipe both the front end surface 13a and the side surface 13d. It is preferable that the second wiping member 32 be disposed in front of the first wiping member 31 in the wiping direction. In this configuration, in the case where contaminants have moved toward the side surface 13d as a result of wiping the front end surface 13a, in the next wiping, the second wiping member 32 that is disposed ahead wipes off the contaminants on the side surface 13d. At this time, the contaminants that have moved from the side surface 13d to the front end surface 13a are wiped off by the first wiping member 31 that follows.

The liquid ejecting apparatus 11 may be provided with a plurality of the liquid ejecting heads 13 arranged at intervals in the wiping direction. In this case, a groove 54 is formed between every two of the liquid ejecting heads 13 arranged in the wiping direction. When the plurality of the liquid ejecting heads 13 are arranged in the wiping direction, the wiping members 31 and 32 sequentially wipe the plurality of liquid ejecting heads 13 while moving in the wiping direction.

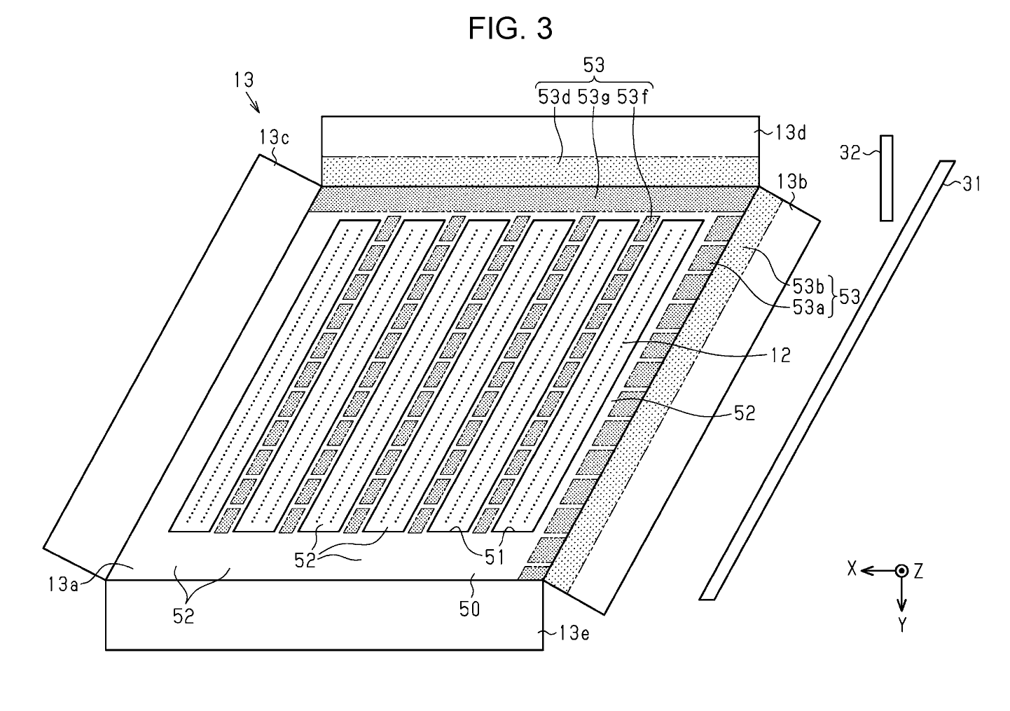

Next, the configuration of the liquid ejecting head 13 will be described in detail with reference to FIG. 3.

In FIG. 3, the upstream surface 13b, the downstream surface 13c, and the side surfaces 13d and 13e of the liquid ejecting head 13 are formed on the same surface as the front end surface 13a. A liquid repellent surface 52, which repels liquid, is provided in portions of the front end surface 13a where the nozzles 12 open. By providing the liquid repellent surface 52, contaminants such as liquid do not tend to become adhered in the vicinity of the openings of the nozzles 12. In the case where the fixing frame 50 is present, it is preferable that the inside of the opening portions 51 be the liquid repellent surface 52. In this case, on the front end surface 13a, a plurality of the liquid repellent surfaces 52 are provided, one for each nozzle group, at intervals in the wiping direction. In the case where a plurality of nozzle rows are provided at intervals in the wiping direction, a plurality of the liquid repellent surfaces 52 may be provided, one for each of the nozzle rows, in the wiping direction at spaced intervals.

On the upstream surface 13b and the front end surface 13a, an upstream lyophilic surface 53b and a front end lyophilic surface 53a are provided as portions of a lyophilic surface 53 that has a higher affinity for liquid than the liquid repellent surface 52. The upstream lyophilic surface 53b, which is the portion of the lyophilic surface 53 on the upstream surface 13b, is connected to the front end lyophilic surface 53a, which is the portion of the lyophilic surface 53 on the front end surface 13a. The liquid repellent surface 52 can be formed by subjecting the liquid ejecting head 13 including the fixing frame 50 to a liquid repellent treatment. The lyophilic surface 53 can be formed, for example, by subjecting the liquid ejecting head 13 to a liquid repellent treatment and then cutting the target portion with a laser or the like to form the lyophilic surface 53. The lyophilic surface 53 can also be formed by subjecting the target portion of the liquid ejecting head 13 to a lyophilic treatment.

The liquid adhering to the front end surface 13a is repelled by the liquid repellent surface 52 and accumulates on the front end lyophilic surface 53a. Because the contact angle between the liquid adhering to the liquid repellent surface 52 and the contact surface is large, the amount of protrusion of the liquid from the contact surface is large. Because the liquid adhering to the lyophilic surface 53 spreads out, the amount of protrusion of the liquid from the contact surface is small.

It is preferable to provide the front end surface 13a with a plurality of the front end lyophilic surfaces 53a arranged at spaced intervals along the upstream lyophilic surface 53b. In this case, a portion having a lower affinity for the liquid than the lyophilic surface 53 is formed between every two adjacent ones of the front end lyophilic surfaces 53a. For example, in the case where the lyophilic surface 53 is formed by cutting groove shapes with a laser or the like after the liquid ejecting head 13 has been subjected to the liquid repellent treatment, the front end lyophilic surfaces 53a that are groove shaped and the liquid repellent surfaces 52 are alternately formed along the outer edges of the front end surface 13a. As a result, the liquid easily moves to the upstream lyophilic surfaces 53b with the front end lyophilic surfaces 53a, which are groove shaped, serving as passages.

When the upstream lyophilic surface 53b is disposed along the outer edge of the front end surface 13a, which intersects the upstream surface 13b, the liquid easily moves from the front end lyophilic surfaces 53a to the upstream lyophilic surface 53b. When the front end lyophilic surfaces 53a are disposed along the outer edge of the front end surface 13a intersecting the upstream surface 13b, the liquid easily moves from the front end lyophilic surfaces 53a to the upstream lyophilic surface 53b. When the liquid adhering to the front end surface 13a moves to the upstream lyophilic surface 53b, the amount of liquid adhering to the front end surface 13a decreases. As a result, the protrusion amount (protrusion length from the front end surface 13a) of the liquid adhering to the front end surface 13a decreases.

A plurality of intermediate lyophilic surfaces 53f, which are portions of the lyophilic surface 53, may be provided between every two of the liquid repellent surfaces 52 arranged side by side in the wiping direction so as to be arranged at spaced intervals along the liquid repellent surfaces 52. In this case, as a result of the liquid that adheres between every two of the liquid repellent surfaces 52 spreading to the intermediate lyophilic surfaces 53f, the protrusion amount of the liquid adhering to the front end surface 13a decreases. The intermediate lyophilic surfaces 53f may be provided so as to delimit all the nozzle groups or may be provided so as to delimit some of the nozzle groups.

A side end lyophilic surface 53d, which is a portion of the lyophilic surface 53 may be provided on the side surface 13d and a lateral lyophilic surface 53g, which is a portion of the lyophilic surface 53 connected to the side end lyophilic surface 53d, may be provided on the front end surface 13a. When the liquid adhering to the front end surface 13a has been repelled by the liquid repellent surface 52 and has accumulated on the lateral lyophilic surface 53g, the liquid moves to the side surface 13d in a process in which the liquid spreads across the side end lyophilic surface 53d. As a result, the amount of liquid adhering to the front end surface 13a decreases. The liquid that has moved to the side surface 13d is wiped by the second wiping member 32 at the time of wiping. The lateral lyophilic surface 53g may be provided in the form of a band so as to extend along the side end lyophilic surface 53d or may be provided in a plurality at spaced intervals in the wiping direction.

By making the affinity for liquid of the upstream lyophilic surface 53b higher than that of the front end lyophilic surface 53a, the liquid, which has moved from the liquid repellent surface 52 to the front end lyophilic surface 53a, can move to the upstream lyophilic surface 53b. In this case, if the affinity for liquid of the wiping member 31 is made higher than that of the upstream lyophilic surface 53b, the liquid adhering to the front end surface 13a can be efficiently removed by the wiping member 31. Similarly, by making the affinity for liquid of the side end lyophilic surface 53d higher than that of the lateral lyophilic surface 53g, the liquid, which has moved from the liquid repellent surface 52 to the lateral lyophilic surface 53g, can move to the side end lyophilic surface 53d. In this case, if the lyophilic property of the second wiping member 32 is higher than that of the side end lyophilic surface 53d, the liquid adhering to the side surface 13d can be efficiently removed by the second wiping member 32.

It is preferable that the front end lyophilic surface 53a, the lateral lyophilic surface 53g, and the intermediate lyophilic surface 53f be disposed at positions apart from the opening portions 51 in the fixing frame 50. When the peripheral edge of the opening portions 51 in the fixing frame 50 is set to be the liquid repellent surface 52, the liquid adhering to the front end surface 13a does not tend to enter the opening portions 51. As a result, the movement of the liquid from the front end surface 13a that forms the fixing frame 50 toward the nozzles 12 is suppressed.

As illustrated in FIG. 4, when the closed space is formed, the cap 22 preferably comes into contact with a position including the lyophilic surface 53 of the liquid ejecting head 13. For example, the front end of the cap 22 is preferably brought into contact with the front end lyophilic surface 53a, the intermediate lyophilic surface 53f, or the lateral lyophilic surface 53g of the liquid ejecting head 13 (refer to FIG. 3). As a result, the liquid adhering to the front end surface 13a is guided toward the cap 22.

When the affinity for the liquid of the cap 22 is higher than that of the front end lyophilic surface 53a, the intermediate lyophilic surface 53f, or the lateral lyophilic surface 53g, the liquid on the front end surface 13a that has moved from the liquid repellent surfaces 52 to the lyophilic surface 53 can be moved into the cap 22. In this case, when the affinity for the liquid of the upstream lyophilic surface 53b and the side end lyophilic surface 53d (refer to FIG. 3) is higher than that of the cap 22, movement of the liquid from the upstream surface 13b and the side surface 13d to the front end surface 13a is suppressed.

Next, the operation of the liquid ejecting apparatus 11 of this embodiment will be described.

The liquid adhering to the front end surface 13a is repelled by the liquid repellent surface 52 and moves to the lyophilic surface 53. Consequently, contaminants such as liquid do not tend to become adhered to the openings of the nozzles 12.

After the liquid repelled by the liquid repellent surface 52 has moved to the front end lyophilic surface 53a or the lateral lyophilic surface 53g, it spreads from the front end lyophilic surface 53a and the lateral lyophilic surface 53g to the upstream lyophilic surface 53b and the side end lyophilic surface 53d, respectively. Therefore, protrusion of the liquid adhering to the front end surface 13a is suppressed. As a result, the liquid does not tend to adhere to the medium 99 passing near the liquid ejecting head 13.

At the time of wiping, the first wiping member 31 wipes the upstream surface 13b and the front end surface 13a, and the second wiping member 32 wipes the side surface 13d. As a result, the liquid that has moved from the front end surface 13a to the upstream surface 13b and the side surface 13d is removed.

As illustrated in FIG. 5, when there are a first liquid ejecting head 13F and a second liquid ejecting head 13S as two of the liquid ejecting heads 13 arranged side by side in the wiping direction, the liquid wiped from the first liquid ejecting head 13F located upstream in the wiping direction sometimes enters the groove 54. When the liquid accumulates in the groove 54 and the wiping member 31 passes therethrough, the liquid is drawn from the groove 54 and may adhere to the front end surface 13a of the second liquid ejecting head 13S located downstream in the wiping direction.

In this case, the liquid adhering to the front end surface 13a accumulates on the front end lyophilic surface 53a and spreads across the upstream lyophilic surface 53b. In this way, the liquid that has moved from the groove 54 to the front end surface 13a during wiping returns to the groove 54 again.

For the liquid ejecting head 13 located at the furthest downstream side in the wiping direction, the lyophilic surface 53 may be provided on the downstream surface 13c; however, for the first liquid ejecting head 13F, which is the liquid ejecting head 13 located downstream in the wiping direction, it is preferable to provide the liquid repellent surface 52 on the downstream surface 13c. Then, because liquid does not tend to move toward the first liquid ejecting head 13F from the groove 54, the liquid accumulated in the groove 54 is wiped downstream in the wiping direction at the time of wiping. As described above, by removing the liquid accumulated in the groove 54 with the wiping, contamination due to the liquid accumulated in the groove 54 is suppressed.

According to the liquid ejecting apparatus 11 of this embodiment, the following effects can be obtained.

(1) The liquid adhering to the front end surface 13a is repelled by the liquid repellent surfaces 52 and accumulates on the front end lyophilic surface 53a. Because the front end lyophilic surface 53a is connected to the upstream lyophilic surface 53b on the upstream surface 13b, in the process of the liquid spreading across the lyophilic surface 53, the liquid adhering to the front end surface 13a moves to the upstream surface 13b. The liquid that has moved to the upstream surface 13b is removed by the wiping member 31. As a result, because the protrusion amount of the liquid droplets adhering to the front end surface 13a decreases, when the medium 99 passes through the vicinity of the front end surface 13a, liquid does not tend to become adhered to the medium 99.

(2) A portion having a lower affinity for the liquid than the lyophilic surface 53 is formed between the front end lyophilic surfaces 53a arranged side by side along the upstream lyophilic surface 53b. Therefore, by using the front end lyophilic surfaces 53a defined by the low affinity portions as channels, the liquid adhering to the front end surface 13a can be guided toward the upstream lyophilic surface 53b.

(3) Because the upstream lyophilic surface 53b is located along the outer edge of the upstream surface 13b intersecting the front end surface 13a, the liquid easily moves from the front end lyophilic surface 53a to the upstream lyophilic surface 53b.

(4) Because the front end lyophilic surface 53a lies along the outer edge of the front end surface 13a that intersects the upstream surface 13b, the liquid easily moves from the front end lyophilic surface 53a to the upstream lyophilic surface 53b.

(5) The liquid adhering between two of the liquid repellent surfaces 52 spreads across the intermediate lyophilic surface 53f, so that protrusion of the droplets adhering to the front end surface 13a is suppressed.

(6) The wiping member 31 extending in the direction in which the nozzles 12 are arranged side by side can efficiently wipe the vicinity of the openings of the plurality of nozzles 12.

(7) In the fixing frame 50, the lyophilic surface 53 is arranged at a position distant from the opening portions 51 so that the liquid adhering to the fixing frame 50 does not tend to move toward the nozzles 12.

(8) When the liquid adhering to the front end surface 13a is repelled by the liquid repellent surface 52 and accumulates on the lateral lyophilic surface 53g, the liquid moves to the side surface 13d in a process in which the liquid spreads across the side end lyophilic surface 53d. The liquid that has moved to the side surface 13d is removed by the second wiping member 32. As a result, because the amount of liquid adhering to the liquid ejecting head 13 is reduced, when the medium 99 passes near the liquid ejecting head 13, the liquid does not tend to adhere to the medium 99.

(9) When the cap 22 contacts the front end lyophilic surface 53a, the liquid adhering to the front end surface 13a can be moved into the cap 22. Thereby, the amount of the liquid adhering to the front end surface 13a can be reduced.

(10) The liquid removed by the wiping member 31 from the first liquid ejecting head 13F may become adhered to the second liquid ejecting head 13S in the wiping direction. The liquid adhering to the front end surface 13a of the second liquid ejecting head 13S enters the groove 54 formed between the second liquid ejecting head 13S and the first liquid ejecting head 13F in the process of spreading across the upstream lyophilic surface 53b. Therefore, it is possible to reduce the amount of liquid adhering to the front end surface 13a of the second liquid ejecting head 13S. Therefore, when the medium 99 passes through the vicinity of the second liquid ejecting head 13S, the liquid does not tend to become adhered to the medium 99.

The above embodiment may be modified as in the following modification examples. The configurations included in the above embodiment and the configurations included in the following modification examples may be freely combined or the configurations included in the following modifications may be freely combined.

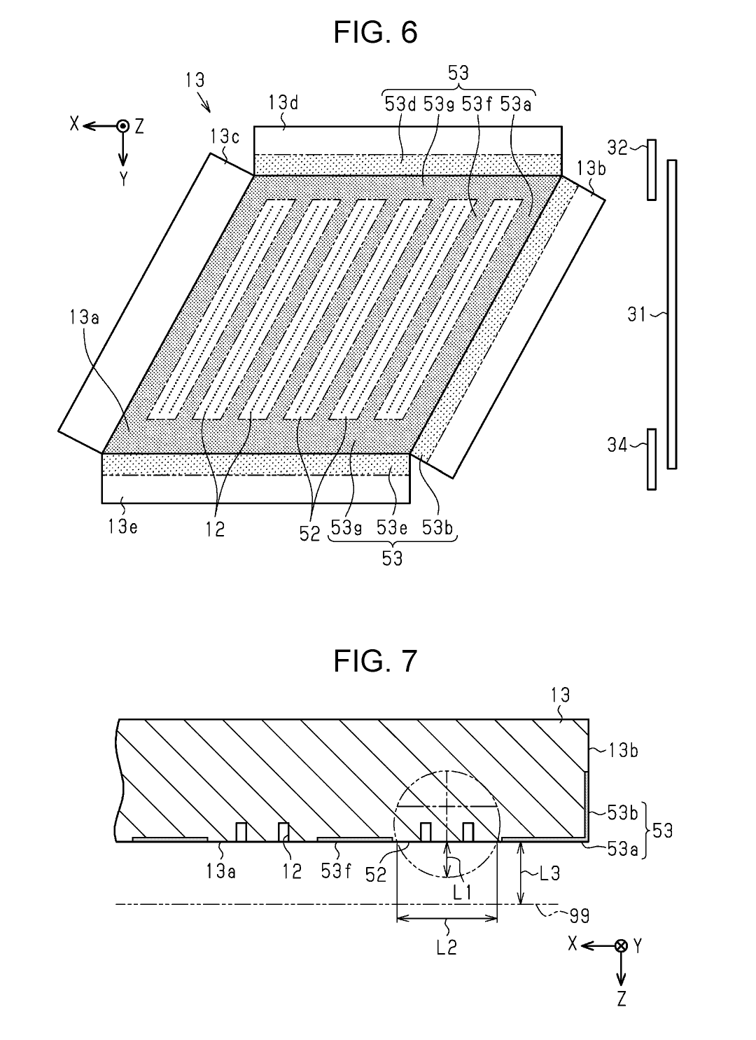

As in the first modification example illustrated in FIG. 6, the liquid ejecting head 13 need not have the fixing frame 50.

As in the first modification example illustrated in FIG. 6, the front end lyophilic surfaces 53a may be provided as strips that extend along the upstream lyophilic surface 53b. In this case, the front end lyophilic surfaces 53a may be connected to the lateral lyophilic surfaces 53g.

As in the first modification example illustrated in FIG. 6, the intermediate lyophilic surfaces 53f may be provided as strips that extend along the liquid repellent surfaces 52. In this case, the intermediate lyophilic surfaces 53f may be connected to the lateral lyophilic surfaces 53g.

As in the first modification example illustrated in FIG. 6, a side end lyophilic surface 53e, which is a portion of the lyophilic surface 53, may be provided on the side surface 13e and the lateral lyophilic surface 53g, which is a portion of the lyophilic surface 53 connected to the side end lyophilic surface 53e, may be provided on the front end surface 13a.

As in the first modification example illustrated in FIG. 6, a third wiping member 34 may be provided as a wiping member capable of wiping the side surface 13e.

As in the first modification example illustrated in FIG. 6, the wiping member 31 may extend diagonally with respect to the arrangement direction of the nozzles 12. For example, in the case where the nozzle rows diagonally extend with respect to the width direction X and the transport direction Y, the wiping member 31 may extend in the transport direction Y.

As indicated by the two-dot chain line in FIG. 7, in the case where the protrusion amount L1 when the liquid adhering to the liquid repellent surface 52 of the liquid ejecting head 13 in the first modification example tries to become a spherical droplet due to surface tension is about one third the diameter of a sphere corresponding to the spherical droplet, the maximum diameter L2 of the droplet is about 2.82 times L1. The maximum diameter L2 of the droplet increases with enlargement of the liquid repellent surface 52, and the protrusion amount L1 of the droplet increases as the liquid repellent surface 52 is enlarged. Assuming that the distance between the front end surface 13a and the medium 99 is L3, when the protrusion amount L1 is equal to or larger than L3, the liquid droplet adhering to the liquid repellent surface 52 comes into contact with the medium 99. In order to avoid contact between the liquid droplet and the medium 99, it is preferable that the length of the liquid repellent surface 52 (substantially corresponding to L2) sandwiched between the lyophilic surface 53 in a predetermined direction (for example, the wiping direction) be less than three times (more specifically, less than 2.82) L3.

In the case where the maximum protrusion amount of the droplet adhering to the lyophilic surface 53 is 0.1 mm, if the protrusion amount L1 of the droplet adhering to the liquid repellent surface 52 is less than 0.1 mm, the liquid does not tend to adhere to the medium 99. The maximum diameter L2 of the droplet when L1 is 0.1 mm is about 0.28 mm. Therefore, the length (substantially corresponding to L2) of the liquid repellent surface 52 sandwiched between portions of the lyophilic surface 53 in a predetermined direction (for example, the wiping direction) may be set to be larger than 0.2 mm.

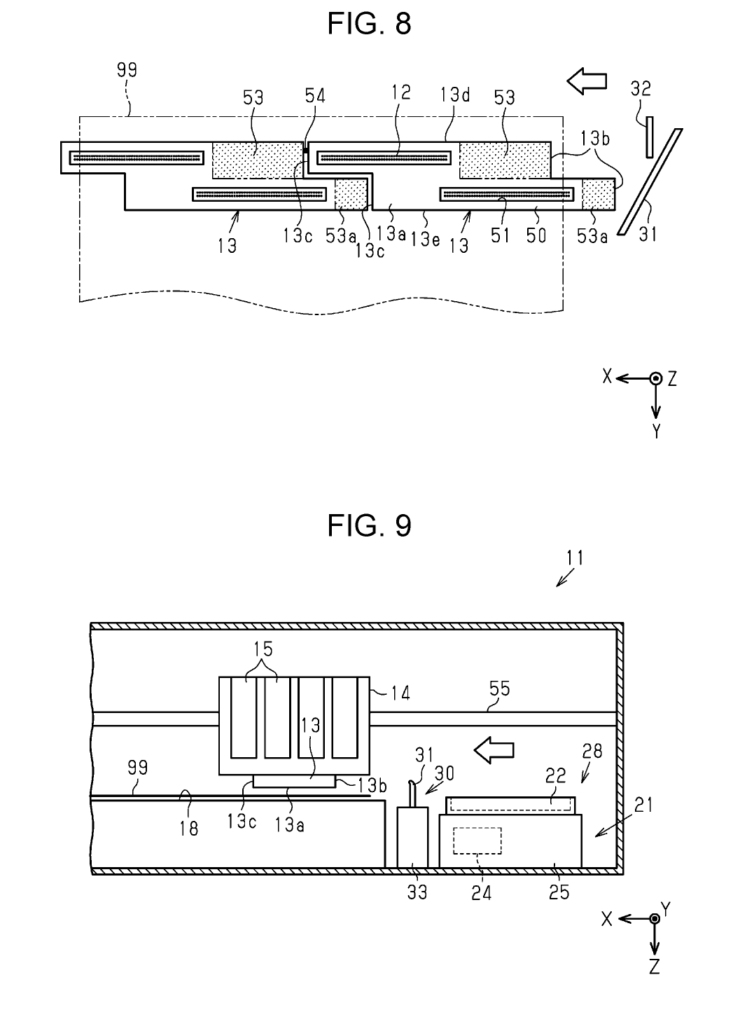

As in the second modification illustrated in FIG. 8, a plurality of the nozzles 12 arranged in the width direction X so as to cover the entire width of the medium 99 may be formed as a plurality of nozzle rows shifted in position in the transport direction Y. These nozzle rows, for example, may be formed as nozzle groups of two rows of nozzles arranged side by side in the transport direction Y. In this case, both end sides of the liquid ejecting head 13 in the wiping direction may be formed stepwise in accordance with the arrangement of the nozzle groups. As a result, the groove 54 between two of the liquid ejecting heads 13 arranged side by side in the wiping direction (indicated by the hollow arrow in FIG. 8) may have a bent shape. In this case, the lyophilic surface 53 may be provided in a region along the upstream surface 13b and the side surface 13d of the liquid ejecting head 13.

As in the second modification example illustrated in FIG. 8, the wiping member 31 may be disposed so as to diagonally intersect with the downstream surface 13c of the liquid ejecting head 13 or the groove 54 at the time of wiping. According to this configuration, liquid droplets do not tend to scatter when the wiping member 31 leaves the liquid ejecting head 13.

As in the second modification example illustrated in FIG. 8, the wiping member 31 may be arranged so as to extend diagonally with respect to the longitudinal direction (width direction X) of the liquid ejecting head 13.

The wiping member 31 may be disposed so as to extend in the lateral direction (the transport direction Y) of the opening portions 51.

The wiping member 31 that extends in the longitudinal direction (width direction X) of the liquid ejecting head 13, which is a line head, may be provided, and the wiping member 31 while moving relative to the liquid ejecting head 13 in the transport direction Y may wipe the front end surface 13a.

The wiping may be performed by moving the liquid ejecting head 13 with respect to the wiping member 31 or wiping may be performed by moving both of the liquid ejecting head 13 and the wiping member 31.

As in the third modification example illustrated in FIG. 9, the liquid ejecting head 13 may be changed to a serial head that prints while reciprocating together with the holding unit 14 in the width direction X along a guide shaft 55. In this case, for example, it is preferable that the transport path 18, the wiping device 30, and the suction mechanism 28 be arranged side by side in the width direction X (movement direction of the liquid ejecting head 13). In this configuration, the front end surface 13a can be wiped by the wiping member 31 while the liquid ejecting head 13 moves in the width direction X or the opposite direction. In FIG. 9, because the wiping member 31 comes into contact with the front end surface 13a when the liquid ejecting head 13 moves in a direction opposite to the width direction X, the direction (width direction X) indicated by a hollow arrow in the drawing becomes the wiping direction.

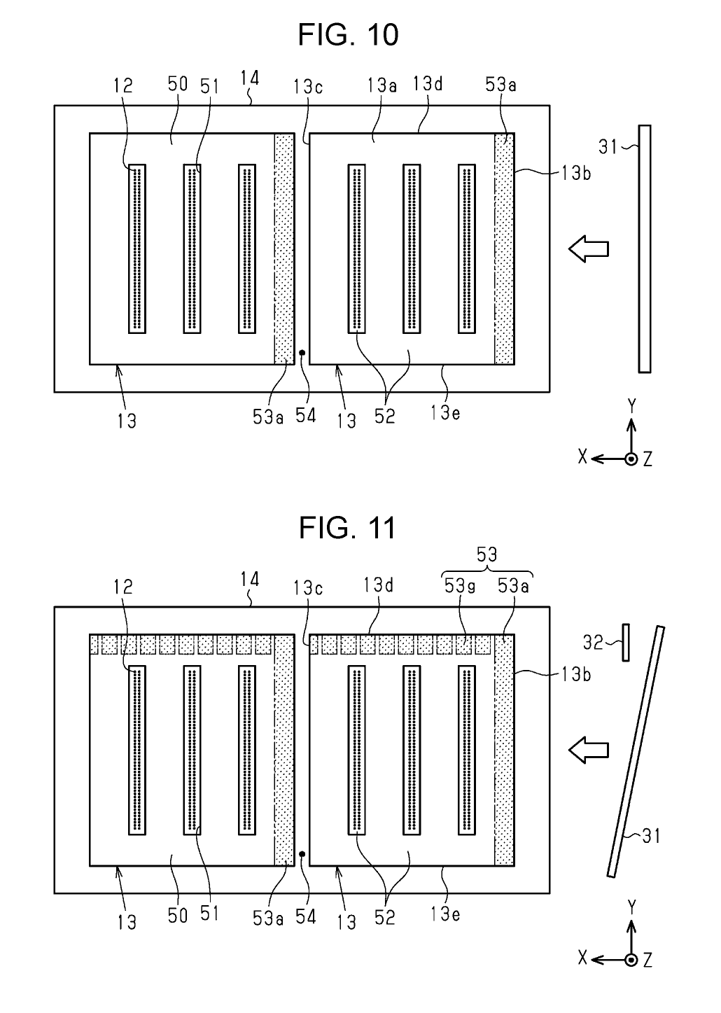

The fourth modification example illustrated in FIG. 10 and the fifth modification example illustrated in FIG. 11 are modification examples for the case where the front end surface 13a of the liquid ejecting head 13 of the serial head as illustrated in FIG. 9 is wiped by the wiping member 31. In FIG. 10 and FIG. 11, the wiping direction is indicated by a hollow arrow. FIG. 10 and FIG. 11 illustrate examples in which two of the liquid ejecting heads 13 are arranged side by side in the wiping direction.

As in the fourth modification example illustrated in FIG. 10, the front end lyophilic surface 53a may be formed in a band shape so as to extend along the outer edge of the front end surface 13a intersecting the upstream surface 13b.

As in the fifth modification example illustrated in FIG. 11, a plurality of lateral lyophilic surfaces 53g may be provided at intervals in the wiping direction along the outer edge of the front end surface 13a intersecting the side surface 13d.

The liquid ejected by the liquid ejecting head 13 is not limited to ink, but may be, for example, a liquid body in which particles of a functional material are dispersed or mixed in a liquid. For example, the liquid ejecting head 13 may eject a liquid material in the form of a dispersion or dissolution including a material such as an electrode material or a coloring material (pixel material) used for manufacturing a liquid crystal display, an EL (electroluminescence) display, a surface emission display, or the like.

The medium 99 is not limited to paper, but may be a plastic film, a thin plate material, a cloth used for a stencil printing machine or the like. The medium 99 may be a clothing item having any shape such as a T-shirt, or it may be a three-dimensional object having any shape such as tableware or stationery items.

The technical ideas grasped from the embodiment and the modifications described above and the operation effects thereof are described below.

### Idea 1

A liquid ejecting apparatus includes a liquid ejecting head including a front end surface, an upstream surface that intersects with the front end surface, and a nozzle that opens at the front end surface, the liquid ejecting head being configured to eject liquid from the nozzle, and a wiping member configured to wipe the front end surface by moving relative to the liquid ejecting head in a wiping direction. The upstream surface is located upstream of the front end surface in the wiping direction. A liquid repellent surface that repels the liquid is provided in a portion of the front end surface where the nozzle opens. A lyophilic surface having a higher affinity for the liquid than the liquid repellent surface is provided on the upstream surface and the front end surface, and an upstream lyophilic surface that is a portion of the lyophilic surface on the upstream surface is connected to a front end lyophilic surface that is a portion of the lyophilic surface on the front end surface.

According to this configuration, the liquid adhering to the front end surface is repelled by the liquid repellent surface and accumulates on the front end lyophilic surface. Because the front end lyophilic surface is connected to the upstream lyophilic surface on the upstream surface, in the process where the liquid spreads across the lyophilic surface, the liquid adhering to the front end surface moves to the upstream surface. The liquid that has moved to the upstream surface is removed by the wiping member. As a result, because the protrusion amount of the droplet adhering to the front end face decreases, even when the medium passes through the vicinity of the front end surface, liquid does not tend to adhere to the medium.

### Idea 2

The liquid ejecting apparatus according to Idea 1 is characterized in that a plurality of front end lyophilic surfaces, each of which is the front end lyophilic surface, arranged side by side at spaced intervals along the upstream lyophilic surface are provided on the front end surface.

According to this configuration, because a portion having a lower affinity for the liquid than the lyophilic surface is formed between the front end lyophilic surfaces arranged side by side along the upstream lyophilic surface, with the front end lyophilic surfaces defined by the low affinity portion serving as passages, the liquid adhering to the front end surface can be guided toward the upstream lyophilic surface.

### Idea 3

The liquid ejecting apparatus according to Idea 1 or Idea 2 is characterized in that the upstream lyophilic surface is disposed along an outer edge of the upstream surface that intersects with the front end surface.

According to this configuration, because the upstream lyophilic surface lies along the outer edge of the upstream surface that intersects with the front end surface, the liquid easily moves from the front end lyophilic surface to the upstream lyophilic surface.

### Idea 4

The liquid ejecting apparatus according to any one of Idea 1 to Idea 3 is characterized in that the front end lyophilic surface is disposed along an outer edge of the front end surface that intersects with the upstream surface.

According to this configuration, because the front end lyophilic surface lies along the outer edge of the front end surface that intersects with the upstream surface, the liquid tends to move from the front end lyophilic surface to the upstream lyophilic surface.

### Idea 5

The liquid ejecting apparatus according to any one of Idea 1 to Idea 4 is characterized in that a plurality of nozzle rows formed by arranging a plurality of nozzles, each of which is the nozzle, side by side are arranged on the front end surface side by side at spaced intervals in the wiping direction, and a plurality of liquid repellent surfaces, each of which is the liquid repellent surface, are provided for each of the nozzle rows on the front end surface at spaced intervals in the wiping direction, and a plurality of intermediate lyophilic surfaces, which are portions of the lyophilic surface, are arranged side by side at spaced intervals along the liquid repellent surfaces, each intermediate lyophilic surface being arranged between two of the liquid repellent surfaces arranged side by side in the wiping direction.

According to this configuration, the liquid that has adhered between the two liquid repellent surfaces spreads across the intermediate lyophilic surface, so that the protrusion of the droplet adhering to the front end surface is suppressed.

### Idea 6

The liquid ejecting apparatus according to Idea 5 is characterized in that the wiping member extends in a direction in which the plurality of nozzles are arranged side by side.

According to this configuration, it is possible to efficiently wipe the vicinity of the openings of the plurality of nozzles by using the wiping member.

### Idea 7

The liquid ejecting apparatus according to Idea 5 or Idea 6 is characterized in that the liquid ejecting head includes a fixing frame that has an opening portion exposing an opening of the nozzle and that protrudes more than the opening of the nozzle, and the front end lyophilic surface and the intermediate lyophilic surface are disposed at positions away from the opening portion in the fixing frame.

According to this configuration, because the lyophilic surface is arranged at a position away from the opening portion in the fixing frame, liquid adhering to the fixing frame is less likely to move toward the nozzles.

### Idea 8

The liquid ejecting apparatus according to any one of Idea 1 to Idea 7 is characterized in that the liquid ejecting head includes a side surface extending in the wiping direction, and a second wiping member that wipes the side surface by moving relative to the liquid ejecting head in the wiping direction when the wiping member is used as a first wiping member, and a side end lyophilic surface that is a portion of the lyophilic surface is provided on the side surface, and a lateral lyophilic surface that is a portion of the lyophilic surface connected to the side end lyophilic surface is provided on the front end surface.

According to this configuration, when the liquid adhering to the front end surface is repelled by the liquid repellent surface and accumulates on the lateral lyophilic surface, the liquid moves to the side surface in the process of the liquid spreading toward the side end lyophilic surface. The liquid that has moved to the side surface is removed by the second wiping member. As a result, because the amount of liquid adhering to the liquid ejecting head decreases, the liquid does not tend to adhere to the medium when the medium passes near the liquid ejecting head.

### Idea 9

The liquid ejecting apparatus according to any one of Idea 1 to Idea 8 further includes a cap configured to form a closed space to which the nozzle opens and is characterized in that the cap makes contact with the front end lyophilic surface of the liquid ejecting head when the closed space is formed.

According to this configuration, when the cap makes contact with the front end lyophilic surface, the liquid adhering to the front end surface can be moved into the cap. This makes it possible to reduce the amount of liquid adhering to the front end surface.

### Idea 10

The liquid ejecting apparatus according to any one of Idea 1 to Idea 9 further includes a plurality of liquid ejecting heads, each of which is the liquid ejecting head, arranged side by side at spaced intervals in the wiping direction.

According to this configuration, the liquid removed from the first liquid ejecting head by the wiping member may become adhered to the second liquid ejecting head located downstream thereof in the wiping direction. The liquid adhering to the front end surface of the second liquid ejecting head enters a gap between the first liquid ejecting head and the second liquid ejecting head in the process of spreading across the upstream lyophilic surface. Therefore, it is possible to reduce the amount of liquid adhering to the front end surface of the second liquid ejecting head. Therefore, when the medium passes near the second liquid ejecting head, liquid does not tend to become adhered to the medium.

The entire disclosure of Japanese Patent Application No. 2017-022160, filed Feb. 9, 2017 is expressly incorporated by reference herein.

What is claimed is:

1. A liquid ejecting apparatus comprising:
a liquid ejecting head including a front end surface, an upstream surface that intersects with the front end surface, and a nozzle that opens at the front end surface, the liquid ejecting head being configured to eject liquid from the nozzle; and
a wiping member configured to wipe the front end surface by moving relative to the liquid ejecting head in a wiping direction, wherein
the upstream surface is located upstream of the front end surface in the wiping direction,
a liquid repellent surface that repels the liquid is provided in a portion of the front end surface where the nozzle opens, and
a lyophilic surface having a higher affinity for the liquid than the liquid repellent surface is provided on the upstream surface and the front end surface, and an upstream lyophilic surface that is a portion of the lyophilic surface on the upstream surface is connected to a front end lyophilic surface that is a portion of the lyophilic surface on the front end surface.

2. The liquid ejecting apparatus according to claim 1, wherein a plurality of front end lyophilic surfaces, each of which is the front end lyophilic surface, arranged side by side at spaced intervals along the upstream lyophilic surface are provided on the front end surface.

3. The liquid ejecting apparatus according to claim 1, wherein the upstream lyophilic surface is disposed along an outer edge of the upstream surface that intersects with the front end surface.

4. The liquid ejecting apparatus according to claim 1, wherein the front end lyophilic surface is disposed along an outer edge of the front end surface that intersects with the upstream surface.

5. The liquid ejecting apparatus according to claim 1, wherein
a plurality of nozzle rows formed by arranging a plurality of nozzles, each of which is the nozzle, side by side are arranged on the front end surface side by side at spaced intervals in the wiping direction,
a plurality of liquid repellent surfaces, each of which is the liquid repellent surface, are provided for each of the nozzle rows on the front end surface at spaced intervals in the wiping direction, and
a plurality of intermediate lyophilic surfaces, which are portions of the lyophilic surface, are arranged side by side at spaced intervals along the liquid repellent surfaces, each intermediate lyophilic surface being arranged between two of the liquid repellent surfaces arranged side by side in the wiping direction.

6. The liquid ejecting apparatus according to claim 5, wherein the wiping member extends in a direction in which the plurality of nozzles are arranged side by side.

7. The liquid ejecting apparatus according to claim 5, wherein
the liquid ejecting head includes a fixing frame that has an opening portion exposing an opening of the nozzle and that protrudes more than the opening of the nozzle, and
the front end lyophilic surface and the intermediate lyophilic surface are disposed at positions away from the opening portion in the fixing frame.

8. The liquid ejecting apparatus according to claim 1, wherein
the liquid ejecting head includes a side surface extending in the wiping direction, and a second wiping member that wipes the side surface by moving relative to the liquid ejecting head in the wiping direction when the wiping member is used as a first wiping member,
a side end lyophilic surface that is a portion of the lyophilic surface is provided on the side surface, and
a lateral lyophilic surface that is a portion of the lyophilic surface connected to the side end lyophilic surface is provided on the front end surface.

9. The liquid ejecting apparatus according to claim 1, further comprising a cap configured to form a closed space to which the nozzle opens, wherein
the cap makes contact with the front end lyophilic surface of the liquid ejecting head when the closed space is formed.

10. The liquid ejecting apparatus according to claim 1, further comprising a plurality of liquid ejecting heads, each of which is the liquid ejecting head, arranged side by side at spaced intervals in the wiping direction.
